(19) United States
(12) Patent Application Publication
(10) Pub. No.: US 2004/0249553 A1
(43) Pub. Date: Dec. 9, 2004

(54) Method and arrangement for reading out data of a fuel metering system

(76) Inventor: Uwe Liskow, Asperg (DE)

Correspondence Address: Walter Ottesen, Patent Attorney, PO Box 4026, Gaithersburg, MD, 20885-4026, US

(21) Appl. No.: 10/494,226

(22) PCT Filed: Sep. 23, 2002
(86) PCT No.: PCT/DE02/03567

(30) Foreign Application Priority Data
Oct. 30, 2001 (DE) 10153520.1

(51) Int. Cl. F02D 41/24

(52) U.S. Cl. 701/104

(57) ABSTRACT

The invention relates to a method for reading out data of a fuel metering system for an internal combustion engine of a motor vehicle, especially of a fuel pump or an injector. Data of the fuel pump and/or of the injector are assigned at least to one electronic component; the data are considered by a control unit of the motor vehicle in the control of the internal combustion engine of the motor vehicle. The control unit includes a cylinder-equalization function.

The invention relates to a method for reading out data of a fuel metering system for an internal combustion engine of a motor vehicle, especially of a fuel pump or an injector. Data of the fuel pump and/or of the injector are assigned at least to one electronic component. The data are considered by a control unit of the motor vehicle during the control of the internal combustion engine of the motor vehicle. The control unit includes a cylinder equalization function.

The invention further relates to a corresponding arrangement for reading out data of a fuel metering system for an internal combustion engine of a motor vehicle.

### STATE OF THE ART

A fuel supply system for an internal combustion engine is known from GB 2,118,325 A. In this system, a pump is subjected to a test run during manufacture. The data which results during the test run are stored in a memory which is integrated into or on the pump. The memory can be a read-only-memory (ROM) or also a network configured of discrete components. A network of discrete electrical components can, for example, be a network of electrical resistors. In GB 2,118,325 A, it is, on the one hand, disclosed that the test data, which are stored in the memory, are permanently in communication with a control system so that the data can be read out of the memory by the control unit during the operation of the internal combustion engine. Alternatively, it is provided that the data is read out from the memory by the control apparatus through a special cable. This special cable can be removed after a first read-out operation.

DE 35 10 157 A1 discloses an electromagnetically actuated fuel injection valve. The fuel injection valve is provided for an internal combustion engine and is driven by an injection electronic. The current pulse outputted by the injection electronic opens the fuel injection valve in dependence upon the air quantity. A current pulse of pregiven duration corresponds to a corresponding quantity of fuel which is dependent upon an identifier of the fuel injection valve, that is, dependent upon deviations from a desired identifier. An electrical resistor is arranged on each fuel injection valve and is dimensioned to be proportional to the characteristic quantity, that is, to the deviation from the desired characteristic quantity of the fuel injection valve. The resistor communicates with the injection electronics for influencing the injection time in order to compensate deviations of the identifier from a desired quantity. In correspondence to DE 35 10 157 A1, it is possible to do without a very tightly tolerated mechanical adjustment and, in lieu thereof, to detect the so-called identifier of the manufactured fuel injection valve and to code the same via a corresponding resistor. The resistor is mounted in an insulated part of the fuel injection valve and is in electrical contact with the injection electronics via a permanent connection.

DE 198 51 797 A1 discloses an electric circuit for storing/reading out technical data of a fuel metering system. A capacitor and/or a resistor is provided on the fuel metering system and has a characteristic value which is assigned to the technical data which is to be read out or stored. The capacitor and/or resistor is connected to an evaluation electronics for measuring the characteristic value of the capacitor and/or resistor. The capacitor and/or resistor is connected to the electric ground of the vehicle. The value of the resistor or capacitor utilized can be determined in correspondence to the selected evaluation electronics. For example, the evaluation electronics can be configured for generating a pulse and for evaluating a branch response. However, current pulses of other sources can be evaluated in a corresponding manner. In this connection, an evaluation electronics having an alternating-current source is, inter alia, mentioned which can evaluate an occurring alternating voltage.

From U.S. Pat. No. 5,575,264, it is known to integrate an EPROM into a fuel injection valve. Technical data of the fuel injection valve can be stored in the EPROM and this data is transferred into a motor vehicle control apparatus. In the motor vehicle control apparatus, a software is, in turn, present which correspondingly adapts the drive signals for the fuel injection valves by means of the data transmitted from the EPROM.

The non-published German patent

application DE 100 07 691.2-26 describes a method for storing and/or reading out data of a fuel metering system, especially of a fuel pump or of an injector. Data of the fuel pump and/or of the injector are assigned to at least one electronic component. The data are considered by a control unit in the control of the fuel metering system. During a first time segment, the component (resistor, capacitor or EPROM) is mechanically and/or electrically connected to the control unit and, during a second time segment, is mechanically and/or electrically separated from the control unit and/or the fuel metering unit. This is achieved with a two-latch connector wherein a corresponding resistor is integrated. The first stage or latch of the connector functions for reading out the data and the second latch is used for the normal operation. Accordingly, before starting the internal combustion engine (that is, the motor vehicle) for the first time, the connector is first brought into the first latch and the characteristic data is taken over into a vehicle control apparatus. In the second latch position, which is used next, there is no connection between the electronic component and the motor vehicle control apparatus. Ahead of the first start of the motor or of the motor vehicle, an alternate solution provides that a special program runs which charges the classification resistor with a very high current value and/or a very high voltage value which leads to an automatic separation of a desired interrupt location similar to a fuse. As a further alternative, it can be provided that, in the context of the manufacture of the motor vehicle after the read-in of the resistance value, a manual interruption of one of the feed lines or both feed lines takes place. This can, for example, take place via breaking off the resistor which projects beyond the surface of the injector.

DE 33 36 028 C3 discloses an arrangement for influencing control quantities of an internal combustion engine. Here, especially the smooth running of the engine is influenced by cylinder-specific smooth-running desired values and smooth-running actual values combined with the corresponding control. A cylinder-specific actuating signal is pregiven in dependence upon the difference between the smooth-running desired value and the smooth-running actual value. The smooth-running actual value is a quantity which defines an index for the time duration between two combustion time points. The smooth-running desired value is a mean value of the smooth-running actual values of all cylinders. The rough running of a vehicle results from tolerances of the injection component whereby different injection quantities are introduced into the combustion chambers of the cylinders. This fuel quantity difference leads to rapid torque changes which excite the vibration-capable formation of motor and chassis. These low-frequency vibrations can be damped by a correction of the cylinder-individual fuel injection quantities. The following parameters are applied in the context of DE 33 36 028 C3 which influence the combustion of the internal combustion engine: fuel metering; exhaust-gas recirculation; injection time point; injection duration; air/fuel ratio; and, ignition time point.

An electronic control arrangement is known from DE 198 28 279 A1 by means of which an equalization of the cylinder-individual torque contributions can be carried out for a multi-cylinder internal combustion engine. Here, to adapt the cylinder-individual torque contributions, for example, one of the following is varied: the injected fuel quantity, the ignition time point (for spark-ignition engines), the exhaust-gas recirculation rate or the injection position. The determination of the cylinder-individual torque contributions can take place via the evaluation of the time-dependent course of the rotational movement of the crankshaft or of the camshaft with individual segment times being detected. Alternatively, smooth-running values, which are formed anyway for the combustion misfire detection in the control apparatus, can be utilized. The purpose of the cylinder equalization is to minimize the rough running values with a control concept. Appropriate interventions can be undertaken on the engine in dependence upon the detected pattern and the magnitude of the individual filtered and unfiltered rough running values. Especially in an engine having direct injection, a coking of an injection valve can cause a torque of the corresponding cylinder which is too low. In this case, the corresponding cylinder runs too lean. The main component of the control function is the cylinder-individual PI controller in correspondence to DE 198 28 279 A1.

The cylinder equalization functions especially in gasoline-direct injection systems to compensate for torque differences of individual cylinders during operation of an internal combustion engine. Torque differences of this kind between the individual cylinders can, for example, occur because of existing scattering of injection valves (manufacturing inaccuracies which cannot be avoided) or they can occur when there is injection valve coking. A control for cylinder compensation determines the torque deviations between the individual cylinders on the basis of rough running values during operation of the internal combustion engine. The cylinder torques are, preferably, equalized in a stratified operation by means of adapting the cylinder-individual injection quantity of fuel in the form of a dynamic control. The cylinder equalization functions for cylinder-individual correction of the injection times in dependence upon the cylinder torques which adjust in each case. The corrected injection times have, in turn, an influence on the cylinder torque. In this way, there is a reaction of the injection times on the cylinder torque so that torque differences between the cylinders are controllable to the value zero by means of the control of the cylinder equalization. For large differences between the individual injection valves, the problem occurs that the cylinder equalization control must control out large differences between the torque components of the individual cylinders. In the context of a diagnosis of the cylinder equalization control, the control values are, for example, checked as to large differences in magnitude. In cases wherein the different injection valves deviate greatly from each other with reference to the injection characteristics, the fault evaluation of the cylinder equalization control is made more difficult.

### TASK, SOLUTION AND ADVANTAGES OF THE INVENTION

It is the task of the present invention to better adapt a cylinder-equalization function to unit scatterings of fuel pumps and/or injectors.

The task is solved with a method for reading out data of a fuel metering system for an internal combustion engine of a motor vehicle, especially of a fuel pump and/or of an injector. Data of the fuel pump and/or of the injector are assigned to at least one electronic component. The data are considered by a control unit of the motor vehicle during control of the internal combustion engine of the motor vehicle. The control unit has a cylinder-equalization function and the data are considered in the cylinder-equalization function. The data are applied for characteristic field corrections of the cylinder-equalization function in an especially advantageous manner. The preferred embodiment of the method of the invention provides that the data are read out in a first start of the control unit and are stored in the control unit. In principle, a precontrol of the cylinder-equalization control is undertaken via the consideration of the data in the cylinder-equalization function in accordance with the invention. This affords the special advantage that the control of the cylinder-equalization function must undertake control interventions to a far lesser extent than this would be necessary without the consideration of the data in accordance with the invention. Especially the consideration of the data in accordance with the invention during diagnostic routines and/or fault routines in such a manner that a monitoring of the cylinder-equalization function as to permissible amplitude magnitudes of the control is carried out can thereby take place with much greater precision. For example, it can be recognized from an amplitude of the control value of the cylinder-equalization function which is too large that an injection valve or an injector is contaminated or coked or is generally affected with respect to its function. For diagnoses of this kind, it is very important that the cylinder-compensation function operates exactly in its base function which is achieved with the method of the invention.

The control range of a cylinder-equalization function is, as a rule, limited but ideally, it should be as large as possible. An essential advantage of the method of the invention is that the cylinder-equalization control is relieved by the precontrol with the read-out data and thereby has a wider control range. At the same time, costs can be saved in that injectors can be used with less high specifications. The precontrol with the read-out data has proven a great advantage especially with the preceding described use of injectors having less high specifications. In the extreme case, an engine could not start for an original starting attempt without the method of the invention when the scattering of injectors is too great. Even a poor original start for which no clean run up of the engine is ensured leads to the engine not reaching the necessary operating state in order to execute a cylinder-equalization function. Here, the invention provides a remedy which can compensate the tolerances or scatterings of the injectors in the new state from up to ±20% by considering the data in the precontrol.

A further advantage of the consideration of the data in the cylinder-equalization function is related to the new part data of the injectors changing with time. This effect is characterized as a continuous drift and is countered best by considering the data in the cylinder-equalization function directly during the original start of the engine because the data in the original state or new state correspond to the stored data. When the injector data change with time, this is detected by the cylinder-equalization function and the stored data are continuously adapted so that, for each case, the optimal precontrol data are present in the cylinder-equalization function at each operating time point starting from an optimal original start.

A further embodiment of the invention provides that the data are inputted manually especially via a service interface, for example, during a service center visit and/or during an exchange of the fuel pump or one of the injectors. With this embodiment of the invention, it is possible to exchange individual injectors and/or the fuel pump which, in practice, is not presently possible. As a rule, presently, all injectors are exchanged when there is a defective injector because the possibility is not present to consider the data of the injector in the control unit of the motor vehicle.

The task is furthermore solved by an arrangement of the invention for reading out data of a fuel metering system for an internal combustion engine of a motor vehicle which includes corresponding means in order to carry out the method of the invention.

### DESCRIPTION OF THE EMBODIMENTS

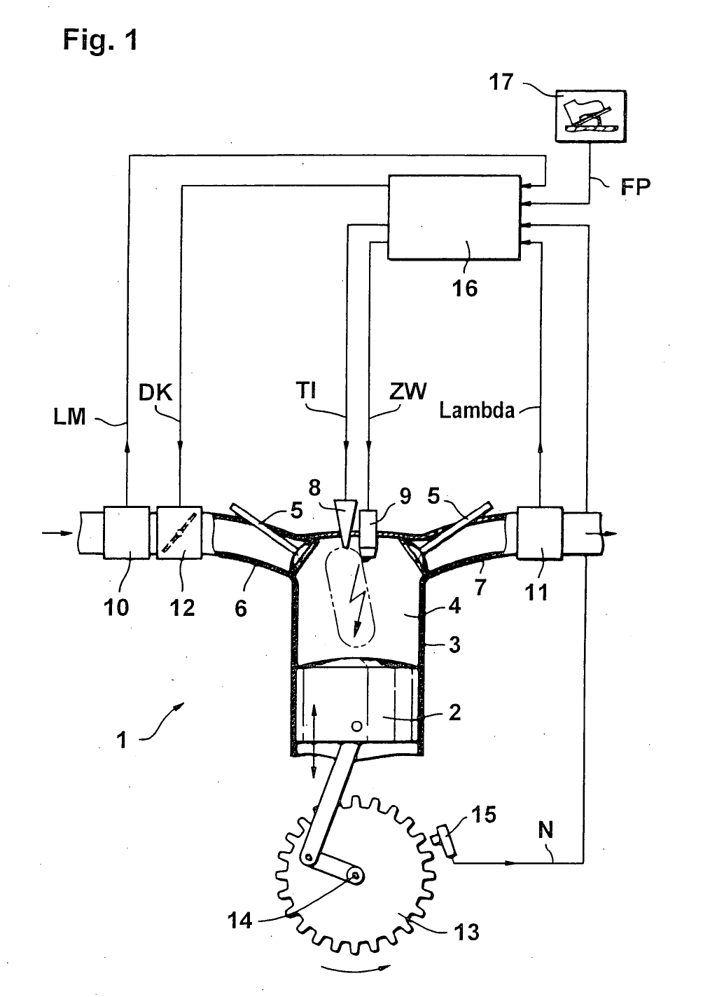

FIG. 1 shows an arrangement of the invention; and,

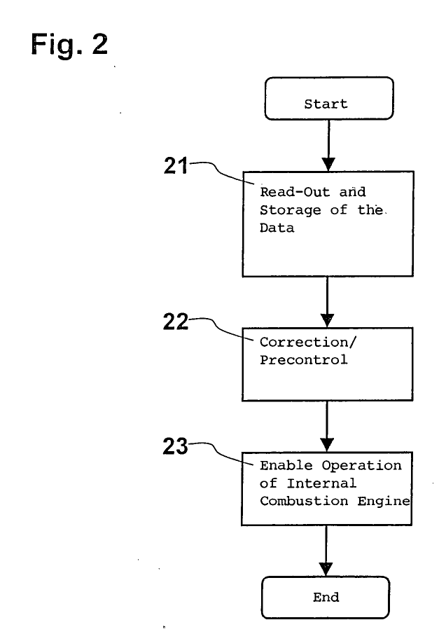

FIG. 2 shows a method of the invention.

FIG. 1 shows a direct-injecting internal combustion engine 1 wherein a piston 2 is movable back and forth in a cylinder 3. The cylinder 3 is provided with a combustion chamber 4 to which intake manifold 6 and exhaust-gas pipe 7 are connected via valves 5. Furthermore, an injection valve 8 and a spark plug 9 are connected to the combustion chamber 4. The injection valve 8 is driveable by a signal TI and the spark plug is driveable by a signal ZW. The signals TI and ZW are transmitted from a control apparatus 16 to the injection valve/injector 8 and spark plug 9, respectively.

The intake manifold 6 is provided with an air mass sensor 10 and the exhaust-pipe 7 is provided with a lambda sensor 11.

The air mass sensor 10 measures the air mass of the fresh air, which is supplied to the intake manifold 6, and generates a signal LM in dependence thereon. The lambda sensor 11 measures the oxygen content of the exhaust gas in the exhaust-gas pipe 7 and generates a signal Lambda in dependence thereon. The signals of the air mass sensor 10 and the lambda sensor 11 are supplied to the control apparatus 16. In the intake manifold 6, a throttle flap 12 is mounted whose rotational position can be adjusted by means of a signal DK from the control apparatus 16.

In a first operating mode, the stratified operation of the internal combustion engine 1, the throttle flap 12 is opened wide. The fuel is injected into the combustion chamber 4 by the injection valve/injector 8 during a compression phase caused by the piston 2. Then, with the aid of the spark plug 9, the fuel is ignited so that the piston 2 is driven in the following work phase by the expansion of the ignited fuel.

In a second mode of operation, the homogeneous operation of the internal combustion engine 1, the throttle flap 12 is partially opened or closed in dependence upon the wanted supplied air mass. The fuel is injected into the combustion chamber 4 by the injection valve 8 during an induction phase caused by the piston 2. Because of the air inducted simultaneously, the injected fuel is swirled and is thereby essentially distributed uniformly in the combustion chamber 4. Thereafter, the air/fuel mixture is compressed during the compression phase in order to then be ignited by the spark plug 9. The piston 2 is driven by the expansion of the ignited fuel.

In stratified operation as also in homogeneous operation, a rotational movement is imparted to a crankshaft 14 by the driven piston via which the wheels of the motor vehicle are finally driven. A toothed wheel 13 is mounted on the crankshaft 14 and the teeth of the toothed wheel are scanned by an rpm sensor 15 mounted directly opposite thereto. The rpm sensor 15 generates a signal from which the rpm (n) of the crankshaft 14 is determined and transmits this signal N to the control apparatus 16. Within the control apparatus 16, a conclusion can be drawn as to torque differences or rough-running values in the individual cylinders based on the time-dependent differences between the individual pulses of the signal (n). These input data for the control apparatus 16 are the basis for a subsequent cylinder-equalization function. Stated otherwise, starting with a determined rough running, a cylinder-equalization function can be carried out. The fuel mass, which is injected into the combustion chamber during stratified operation and during homogeneous operation by the injection valve 8, is controlled (open loop and/or closed loop) by the control apparatus 16, especially with a view to a low fuel consumption and/or a low generation of toxic substances. Furthermore, the injection valve 8 is driven by the control apparatus 16 in accordance with the invention while considering specific data of the injector 8 with a view to an optimal smooth running. For this purpose, the control apparatus 16 is provided with a microprocessor which has a program stored in a storage medium, especially in a read-only memory (ROM) which is suited to execute the complete control (open loop and/or closed loop) of the internal combustion engine 1.

The control apparatus 16 is charged with input signals which define the operating variables of the internal combustion engine and these operating variables are measured by means of sensors. For example, the control apparatus 16 is connected to the air mass sensor 10, the lambda sensor 11 and the rpm sensor 15. Furthermore, the control apparatus 16 is connected to an accelerator pedal sensor 17 which generates a signal FP. The signal FP indicates the position of an accelerator pedal, which is actuable by a driver, and therefore indicates the torque requested by the driver. The control apparatus 16 generates output signals with which the performance of the internal combustion engine 1 can be influenced via actuators in correspondence to the wanted control (open loop and/or closed loop). For example, the control apparatus 16 is connected to the injection valve 8, the spark plug 9 and the throttle flap 12 and generates the signals TI, ZW and TK which are required for driving the same. A service interface is provided, which is not shown in the illustration of FIG. 1, for transferring the data of the fuel pump and/or the injector (that is, of the injection valve) into the control apparatus of the motor vehicle. In order to input the data directly into the control apparatus via the service interface in the case of an exchange or in the case of service, the input value or the data of the injector can be imprinted, for example, clearly on the injector itself.

FIG. 2 shows an embodiment of a method of the invention for reading out data of a fuel metering system. After the start of the method, the data of the injectors or of the fuel pump(s) are read out in step 21. These data can contain information as to through-flow values, tightness values, electrical and/or mechanical characteristics or general classification codes. In the embodiment shown in FIG. 2, the data are read out during the first starting of the motor vehicle into which the fuel metering system is integrated. This is therefore the so-called original start of the motor vehicle with the corresponding fuel metering system. After the read-out of the data, these data are stored in the memory of the control apparatus.

In the next step 22, the read-out data are used for correcting characteristic fields of the cylinder-equalization function which are stored in the control apparatus. Alternatively, the read-out data can also be used for a precontrol of the cylinder-equalization function. Both alternatives have the great advantage in common that the cylinder-equalization function need undertake only few control interventions in the ideal state because an adaptation of varying manufacturing tolerances of the injectors or fuel pumps takes place because of the consideration of the data in the cylinder-equalization function in accordance with the invention. These few control interventions, in turn, afford the great advantage of a reliable diagnosis or the better execution of fault routines. In a cylinder-equalization function, which does not consider the read-in data, the danger is present that it is difficult to distinguish between a large control intervention because of a fault, for example, of an injector and a large control intervention because of manufacturing-caused tolerances. With the introduction of data in accordance with the intervention, a fault diagnosis of the cylinder-equalization function can be carried out better and more reliably, for example, in the form of a monitoring of the effect of the cylinder-equalization function.

In this embodiment, the step 23 follows step 22. In step 23, the enablement of the operation of the fuel supply system and therewith the internal combustion engine takes place. This can take place in that a corresponding information is changed in the memory of the engine control apparatus which is set during the manufacture of the control apparatus at the factory to a setting “data not read in up to now”. With this measure, it can be prevented that the internal combustion engine is taken into service without previous consideration of the data. This is purposeful in all cases wherein the read in of the data into the control apparatus is externally triggered during the original start, for example, by a control signal. This external triggering of the read in of the data can, for example, be carried out by an operating person, for example, via an engine test unit at the end of the assembly during the production of a motor vehicle.

The method of the invention is ended after the enablement of the start of the internal combustion engine in step 23.

1 to 6 (Cancelled).

7. A method for reading out data of a fuel metering system for an internal combustion engine of a motor vehicle, the fuel metering system including a fuel pump and/or injectors, the method comprising the steps of:
assigning data of at least one of said fuel pump and injectors to an electronic component;
causing a control unit to consider said data during the control of said internal combustion engine of said motor vehicle;
providing said control unit with a cylinder-equalization function; and,
considering said data for a precontrol of the cylinder-equalization function.

8. The method of claim 7, comprising the further step of applying said data to corrections of a characteristic field.

9. The method of claim 7, comprising the further steps of:
reading out said data when said control unit is taken into service; and,
storing said data in said control unit.

10. The method of claim 7, comprising the further step of manually inputting said data in one or more of the following situations:
(a) for service;
(b) for an exchange of said fuel pump; and,
(c) for an exchange of one of said injectors.

11. The method of claim 7, further comprising the step of considering said data in a diagnosis routine and/or in a fault routine.

12. An arrangement for reading out data of a fuel metering system for an internal combustion engine of a motor vehicle, the fuel metering system including a fuel pump and/or injectors, the arrangement comprising:
means for assigning data of at least one of said fuel pump and injectors to an electronic component;
means for causing a control unit to consider said data during the control of said internal combustion engine of said motor vehicle;
means for providing said control unit with a cylinder-equalization function; and,
means for considering said data for a precontrol of the cylinder-equalization function.
